(19) United States
(12) Patent Application Publication
(10) Pub. No.: US 2024/0256734 A1
(43) Pub. Date: Aug. 1, 2024

(54) METHOD, DEVICE, AND STORAGE MEDIUM FOR PASSIVE SINGLE SATELLITE GEOLOCATION OF GROUND-BASED ELECTROMAGNETIC INTERFERENCE SOURCES

(71) Applicant: Intelligent Fusion Technology, Inc., Germantown, MD (US)

(72) Inventors: Dan SHEN, Germantown, MD (US); Genshe CHEN, Germantown, MD (US); Khanh PHAM, Kirtland AFB, NM (US); Erik BLASCH, Arlington, VA (US)

(21) Appl. No.: 18/160,717

(22) Filed: Jan. 27, 2023

(51) Int. Cl. G06F 30/20

(52) U.S. Cl. CPC G06F 30/20; G06F 2111/10

(57) ABSTRACT

The present disclosure provides a method for decentralized optimal control for passive SSG of ground-based EMI sources. The method includes simulating a scenario based on an EMI source and a satellite specified by a TLE file; and calculating positions, velocities and accelerations of the satellite at different time indexes of the simulated scenario; calculating Doppler shifts and Doppler rates according to the positions, the velocities and the accelerations of the satellite at the different time indexes; and implementing a constrained unscented Kalman filter (cUKF) based on the Doppler shifts and the Doppler rates to obtain an updated state; and calculating a recursive constrained posterior Cramér-Rao bound (rcPCRB); and fine tuning the cUKF using the calculated rcPCRB to obtain an updated cUKF.

### GOVERNMENT RIGHTS

The present disclosure was made with Government support under Contract No. FA9453-21-P-0565, awarded by the United States Air Force Research Laboratory. The U.S. Government has certain rights in the present disclosure.

### FIELD OF THE DISCLOSURE

The present disclosure generally relates to the field of satellite navigation technology and, more particularly, relates to a method, a device, and a storage medium for passive single satellite geolocation (SSG) of ground-based electromagnetic interference (EMI) sources.

### BACKGROUND

Interference of satellite communications is a frequent and ongoing concern for both DoD (department of defense) and civilian enterprises. Satellite communications are facing increasingly diverse physical and EMI that transmit radio frequency (RF) signals in X/Ku/K/Ka/Q-bands. Therefore, RF emitter detection and localization is a key enabler for reliable space control, space situational awareness, intelligence surveillance and reconnaissance, satellite communications, positioning, navigation and timing. Geolocation of the interfering sources is an essential step in mitigating or eliminating interference and restoring operations of communication services.

Normally, the EMI signal's direction of arrival (DOA), DOA rate, and Doppler frequency may be explored to determine the EMI's location. DOA and DOA rate-based methods may offer simple geolocation but require relatively strong received signals and long acquisition times, and provide limited geolocation accuracy. A key challenge is to obtain meter-level 3-D space-based geolocation of ground-based EMI sources using a single satellite. Due to the limited power on the satellite and usual clustering environments of EMI sources, passive geolocation methods may be more feasible than active geolocation methods.

Different manners, such as nonlinear least squares and extended Kalman filters, may utilize Doppler information to geolocate EMI sources or emitters. The EKF and iterative nonlinear least squares manners may require low computational capacities, however these manners may suffer initialization issues, be sensitive to system modeling errors and normally call for massive grid searches. Particle filter (PF) techniques may also be applied to Doppler information for accurate geolocation, but the computational efficiency may be low which may be difficult to meet real-time processing requirement.

### BRIEF SUMMARY OF THE DISCLOSURE

One aspect or embodiment of the present disclosure provides a method for passive SSG of ground-based EMI sources. The method includes simulating a scenario based on an EMI source and a satellite specified by a two-line element (TLE) file; and calculating positions, velocities and accelerations of the satellite at different time instants of the simulated scenario; calculating Doppler shifts and Doppler rates according to the positions, the velocities and the accelerations of the satellite at the different time instants; and implementing a constrained unscented Kalman filter (cUKF) based on the Doppler shifts and the Doppler rates; and calculating a recursive constrained posterior Cramér-Rao bound (rcPCRB); and fine tuning the cUKF using the calculated rcPCRB.

Another aspect or embodiment of the present disclosure provides a device for passive SSG of ground-based EMI sources. The device includes a memory, configured to store program instructions for performing a method for passive SSG of ground-based EMI sources; and a processor, coupled with the memory and, when executing the program instructions, configured for: simulating a scenario based on an EMI source and a satellite specified by a TLE file; and calculating positions, velocities and accelerations of the satellite at different time instants of the simulated scenario; calculating Doppler shifts and Doppler rates according to the positions, the velocities and the accelerations of the satellite at the different time instants; and implementing a constrained unscented Kalman filter (cUKF) based on the Doppler shifts and the Doppler rates; and calculating a recursive constrained posterior Cramér-Rao bound (rcPCRB); and fine tuning the cUKF using the calculated rcPCRB.

Another aspect or embodiment of the present disclosure provides a non-transitory computer-readable storage medium, containing program instructions for, when being executed by a processor, performing a method for passive SSG of ground-based EMI sources. The method includes simulating a scenario based on an EMI source and a satellite specified by a TLE file; and calculating positions, velocities and accelerations of the satellite at different time instants of the simulated scenario; calculating Doppler shifts and Doppler rates according to the positions, the velocities and the accelerations of the satellite at the different time instants; and implementing a constrained unscented Kalman filter (cUKF) based on the Doppler shifts and the Doppler rates; and calculating a recursive constrained posterior Cramér-Rao bound (rcPCRB); and fine tuning the cUKF using the calculated rcPCRB.

Other aspects or embodiments of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts a flowchart of an exemplary method for passive SSG of ground-based EMI sources according to various disclosed embodiments of the present disclosure.

FIG. 2 depicts an exemplary system architecture for passive SSG of ground-based EMI sources according to various disclosed embodiments of the present disclosure.

FIG. 3 depicts an exemplary schematic of an EMI location and an orbit on a 2D map according to various disclosed embodiments of the present disclosure.

FIG. 4 depicts an exemplary schematic of an EMI location and an orbit on a 3D map according to various disclosed embodiments of the present disclosure.

FIG. 5 depicts an exemplary procedure to simulate a scenario according to various disclosed embodiments of the present disclosure.

FIG. 6 depicts an exemplary polar plot of a satellite relative to an EMI source according to various disclosed embodiments of the present disclosure.

FIG. 7 depicts an exemplary schematic of calculated Doppler shifts for a C band frequency according to various disclosed embodiments of the present disclosure.

FIG. 8 depicts an exemplary schematic of calculated Doppler shifts and rates for RF bands of interest according to various disclosed embodiments of the present disclosure.

FIG. 9 depicts an exemplary schematic of an initial position and projected sigma points according to various disclosed embodiments of the present disclosure.

FIG. 10 depicts an area shown in Google map corresponding FIG. 9.

FIG. 11 depicts an exemplary schematic of SSG results for a UHF band frequency and a SNR level at −2 dB according to various disclosed embodiments of the present disclosure.

FIG. 12 depicts an exemplary schematic of SSG Results for C Band and SNR=−2 dB according to various disclosed embodiments of the present disclosure.

FIG. 13 depicts an exemplary schematic of SSG Results for X Band and SNR=−2 dB according to various disclosed embodiments of the present disclosure.

FIG. 14 depicts an exemplary schematic of SSG performance for various SNRs and RF bands according to various disclosed embodiments of the present disclosure.

FIG. 15 depicts an exemplary schematic of rcPCRBs for different bands according to various disclosed embodiments of the present disclosure.

### DETAILED DESCRIPTION

References are made in detail to exemplary embodiments of present disclosure, which are illustrated in accompanying drawings. Wherever possible, same reference numbers are used throughout accompanying drawings to refer to same or similar parts.

Rapid and passive Doppler based constrained unscented Kalman filters (cUKFs) for single-satellite-geolocation of ground EMI sources are described in the present disclosure, where such filters may interfere with the uplinks of satellite communication (SATCOM) systems. In the present disclosure, Doppler shifts and Doppler rate-based cUKFs may be designed; recursive constrained posterior Cramér-Rao bound (rcPCRB) for the nonlinear filtering problems may be developed; and numerical simulations of these modules may be implemented to demonstrate the feasibility of developed passive SSG solution on a practical scenario with one satellite and one ground-based EMI source.

According to various embodiments of the present disclosure, a method, a device, and a storage medium for passive SSG of ground-based EMI sources are described hereinafter.

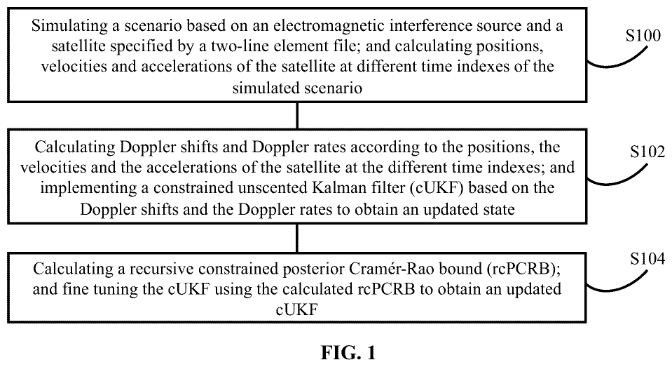

FIG. 1 depicts a flowchart of an exemplary method for passive SSG of ground-based EMI sources according to various disclosed embodiments of the present disclosure. According to various embodiments of the present disclosure, the method for passive SSG of ground-based EMI sources may include the following steps.

In S100, a scenario based on an EMI source and a satellite specified by a TLE file is simulated; and positions, velocities and accelerations of the satellite at different time indexes of the simulated scenario are calculated.

In S102, Doppler shifts and Doppler rates are calculated according to the positions, the velocities and the accelerations of the satellite at the different time indexes; and a constrained unscented Kalman filter (cUKF) is implemented based on the Doppler shifts and the Doppler rates to obtain an updated state.

In S104, a recursive constrained posterior Cramér-Rao bound (rcPCRB) is calculated; and the cUKF is fine-tuned using the calculated rcPCRB to obtain an updated cUKF.

In one embodiment, implementing the cUKF includes calculating sigma points in the cUKF using previous projected state estimates; projecting a part of the sigma points which are not in a constrained solution space into a feasible region to obtain projected sigma points; running the projected sigma points through time update equations to obtain time-projected sigma points and to obtain a time update (for example, obtain updates based on dynamic models); projecting state estimates which are not in the constrained solution space into the feasible region to obtain projected state estimates; and running the time-projected sigma points through measurement update equations to obtain a measurement update, where the time update and the measurement update provide the updated state according to system dynamics and measurements, respectively.

In one embodiment, projecting the part of sigma points which are not in the constrained solution space includes converting each sigma point into a position in a latitude, longitude, and altitude (LLA) coordinate system; setting an altitude of the position to zero or a fixed height to obtain a new position in the LLA coordinate system; and converting the new position in the LLA coordinate system to a position in an Earth-centered and Earth-fixed (ECEF) coordinate system.

In one embodiment, simulating the scenario based on the EMI source and the satellite includes starting with the TLE file and propagating satellite states using a simplified perturbations model 4 (SGP4); and calculating angles of azimuth and elevation in a view of EMI source, where if the elevation angles are greater than +8 degrees, the satellite receives RF signals from the EMI source.

In one embodiment, SGP4 outputs are positions in a True Equator Mean Equinox (TEME) coordinate system; the positions in the TEME coordinate system are converted to positions in an Earth-centered and Earth-fixed (ECEF) coordinate system; and the positions in the ECEF coordinate system are converted to positions in a latitude, longitude, and altitude (LLA) coordinate system.

In one embodiment, after projecting the state estimates which are not in the constrained solution space into the feasible region, the method further includes using the projected state estimates to calculate updated sigma points.

In one embodiment, the constrained solution space is a surface of the Earth.

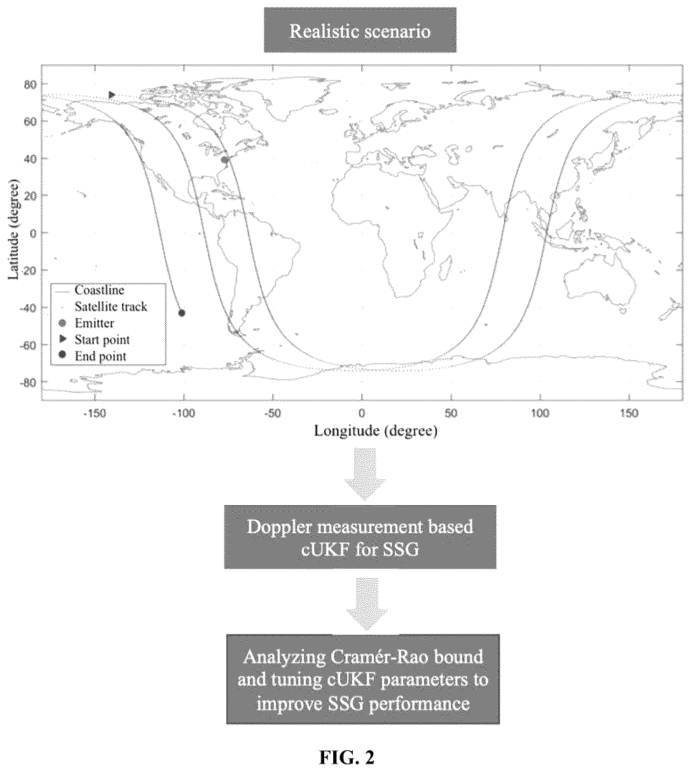

In the present disclosure, the system architecture of the SSG of EMI sources is described herein. FIG. 2 depicts an exemplary system architecture for passive SSG of ground-based EMI sources according to various disclosed embodiments of the present disclosure. The SSG solution may include three main parts as described herein. First, a realistic (practical) scenario may be simulated based on a given EMI source (geolocation) and a given satellite specified by a TLE file. The observation window, when there is a line of sight (LOS) between the satellite and EMI, may be calculated. Dynamic ranges between the single satellite and the EMI source may be calculated. Various satellite communication (SATCOM) waveforms and Doppler information may be further simulated. In the present disclosure, it is assumed that the Doppler shift and Doppler rate may be estimated from received signals. Doppler shifts and Doppler rates may all be exploited. cUKF may be suited for the nonlinearities. cUKF may be faster than particle filter. Earth-bound constraints may not only provide fast convergence, but also improve 3D geolocation accuracy. The effects of clock biases may have been minimized. Then, the Doppler shifts and Doppler rates may be used in cUKF as the measurements. Finally, the performance bounds may be analyzed based on the rcPCRB. Posterior Cramér-Rao Bound may be analyzed, and cUKF parameters may be tuned to improve SSG performance.

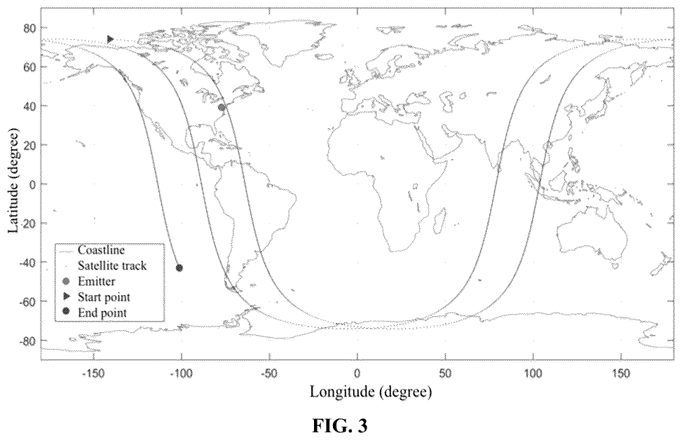

In the present disclosure, a scenario with a ground EMI emitter and a low earth orbit (LEO) satellite is specified herein. FIG. 3 depicts an exemplary schematic of an EMI location and an orbit on a 2D map according to various disclosed embodiments of the present disclosure. The 2-dimensional (2D) view of the scenario is shown in FIG. 3, which illustrates the ground EMI emitter, and the orbit representing the locations of the single satellite for geolocation. Referring to FIG. 3, the orbit may include the start point and the end point. FIG. 4 depicts an exemplary schematic of the EMI location and the orbit on a 3D map according to various disclosed embodiments of the present disclosure. The associated 3-dimensional (3D) view is shown in FIG. 4, where the ECEF coordinate system is used.

To simulate the scenario, a LEO may be selected from the public catalog. The two-line elements may be listed as follows:
1 04139U 00000 16171.89568986 0.00000098 00000-0 25282-4 0 06
2 04139 74.0342 79.1740 0007229 258.8779 101.1575 14.62696590047575

The EMI emitter location may be [39.18644159, −77.24952161, 10] in a LLA format (i.e., coordinate system) with units of degree, degree and meter.

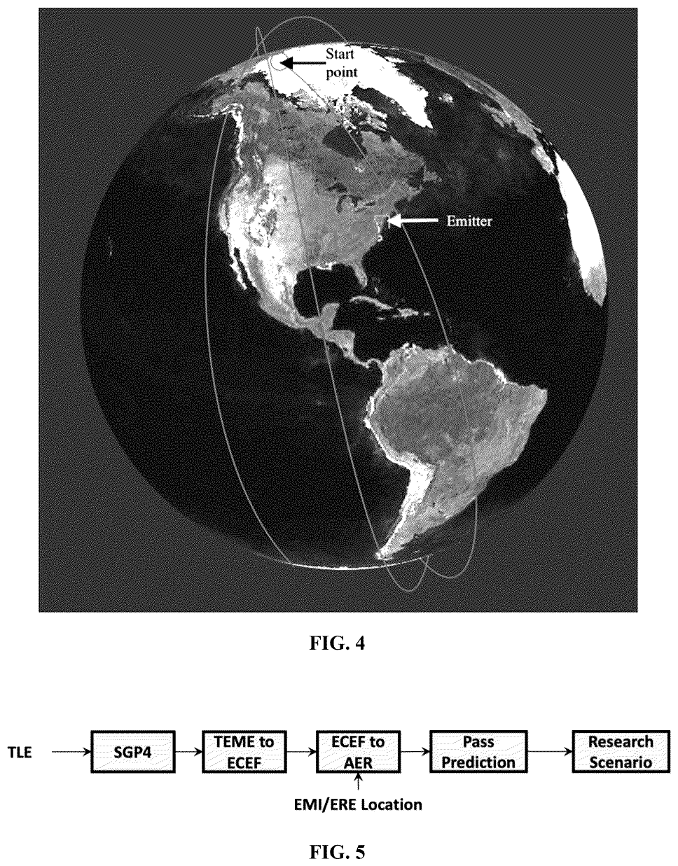

FIG. 5 depicts an exemplary procedure to simulate a scenario according to various disclosed embodiments of the present disclosure. The procedure illustrated in FIG. 5 may be used to simulate the scenario. A TLE file may be started with, and the satellite states using Simplified Perturbations Model 4 (SGP4) may be propagated. Next, the angles of azimuth and elevation in the view of EMI or reference emitter may be calculated. If the elevation angles are greater than +8 degrees, the satellite may receive RF signals from the ground EMI source.

The simulation started on date-time of [3 May 2021 19:03:24.000 UTC], where UTC stands for Coordinated Universal Time. The simulation lasted 3.89 hours with a sampling interval of 10 seconds. The SGP4 propagator may be used to simulate the orbit of the satellite. Since the SGP4 outputs are in TEME frame (i.e., format or coordinate system), the TEME positions may first be converted to the positions in the ECEF coordinate system; and then the positions in the ECEF coordinate system may be converted to the positions in the LLA coordinate system. The LLA results are shown in FIG. 3 and the ECEF results are in FIG. 4.

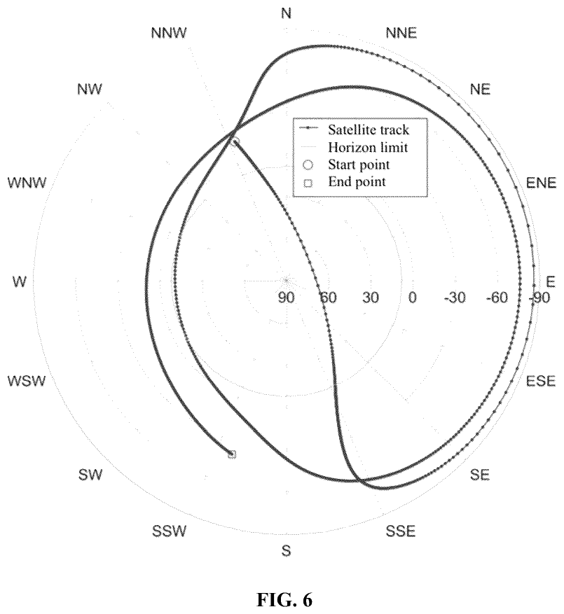

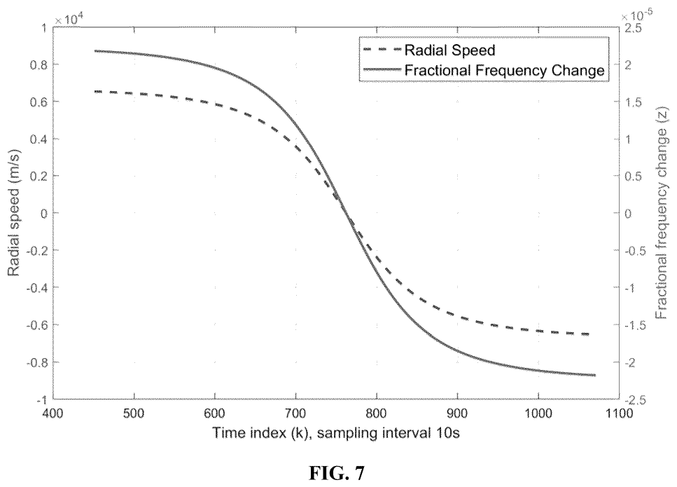

Furthermore, the azimuth angle, elevation angle, and range (i.e., AER) of the satellite relative to the ground emitter may be calculated. FIG. 6 depicts an exemplary polar plot of the satellite relative to the EMI source according to various disclosed embodiments of the present disclosure. The calculation results are illustrated in FIG. 6, where the horizon limit may be set to 8 degrees of the elevation angle. Only satellite locations which have elevation angles between 8 degrees and 90 degrees may be visible to the ground emitter. During the simulation period, there are two windows when the satellite and ground emitter may have line of sight (LOS). The longer window may be 580 seconds (58 observations) while the shorter window may be 140 seconds. In the present disclosure, the longer window may be selected to test developed SSG solution.

Theoretical Doppler shifts are described in the present disclosure hereinafter.

The theoretical Doppler shifts may be calculated as follows:

$$Δ f = f [ \sqrt{\frac{1 + \frac{v}{c}}{1 - \frac{v}{c}}} - 1 ] \approx \frac{v}{c} f \qquad ( 1 )$$

where v denotes the satellite's relative speed to the emitter; c denotes the speed of light, that is, c=3×10⁸ m/s; and f denotes the carrier frequency. v is also called as the slant speed or radial speed, and is considered positive when the satellite is approaching. Then the fractional frequency change may be defined as follows:

$$z = \frac{Δ f}{f} = \sqrt{\frac{1 + \frac{v}{c}}{1 - \frac{v}{c}}} - 1 \qquad ( 2 )$$

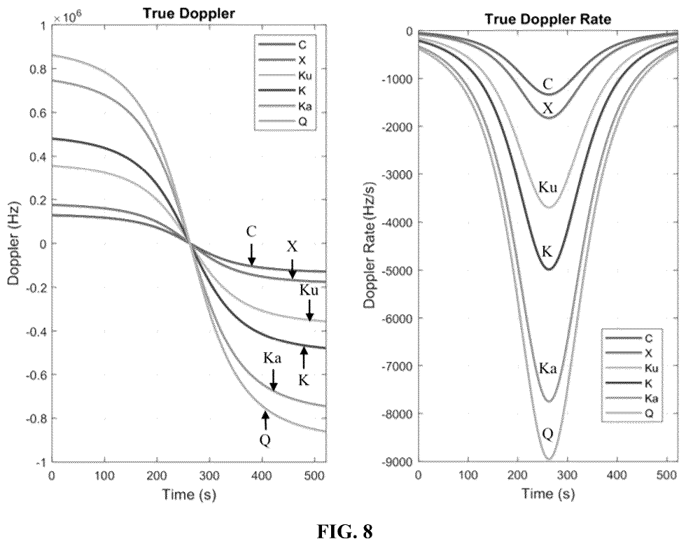

FIG. 7 depicts an exemplary schematic of calculated Doppler shifts for a C band frequency according to various disclosed embodiments of the present disclosure. FIG. 8 depicts an exemplary schematic of calculated Doppler shifts and rates for RF bands of interest according to various disclosed embodiments of the present disclosure. The theoretical Doppler shifts for a C band frequency (f=6.425 GHZ) are shown in FIG. 7. The Doppler (shifts) and Doppler rates of RF bands of interest are shown in FIG. 8.

According to various embodiments of the present disclosure, Doppler based cUKF for SSG is described hereinafter.

A general nonlinear filtering problem may be defined as the following:

$${x}_{k + 1} = {f}_{k} ( {x}_{k} , {w}_{k} ) \qquad ( 3 )$$

$${z}_{k} = {h}_{k} ( {x}_{k} , {v}_{k} ) \qquad ( 4 )$$

$$0 = {g}_{k} ( {x}_{k} ) \qquad ( 5 )$$

where xₖ is the state vector (L×1) at time instant k, zₖ is the measurement vector (N×1), fₖ and hₖ are nonlinear functions, and wₖ and vₖ are independent white noise processes of state and measurement equations, with zero mean (i.e., mean is zero) and covariances Qₖ and Rₖ, respectively. L denotes state dimension, and N denotes measurement dimension. gₖ represents the constraints of a system.

For existing Kalman filter, it is assumed that f (process) and h (measurement) are linear. The state variables may be Gaussian random variables (GRVs). It should be noted that a GRV putting through a linear system is still a GRV, so that the Kalman filter may be optimal for linear systems. For a nonlinear system, characterizing resulting distribution of propagated GRVs may be non-trivial. For UKF, resulting distribution may be represented by a set of 2L+1 deterministic sample points which are called sigma points.

In the present disclosure, the state xx is the EMI location in the ECEF coordinate system. For feasibility, it is assumed that the EMI is stationery and ground-based, and xₖ₊₁=xₖ. hₓ is the measurement model of the Doppler shift and the Doppler rate. gₖ is the condition that xx is on the Earth's surface.

In the present disclosure, the cUKF may be used based on the following observations. cUKF may be ideally suited for dealing with the nonlinearity in the SSG problem (e.g., Doppler). The UKF may provide increased modeling capabilities and robustness compared to the Nonlinear Least Squares (NLLS) and Extended Kalman Filter (EKF) approaches. cUKF may maintain fast computation capability and may not need the large number of samples required for the Particle Filter (PF) to map the nonlinear measurements. Adding the Earth-bound constraint may provide faster convergence and greatly increase the search area and accuracy with a straightforward implementation within the UKF framework.

Given the satellite position pₛ(tₖ), velocity vₛ(tₖ), and acceleration aₛ(tₖ), where tₖ denotes the time index (e.g., integer) at time instant k and s denotes the satellite, the measurement model may be deduced as follows:

$${z}_{k} = [ \begin{matrix}- \frac{1}{λ} ( \frac{{v}_{s}^{T} ( {t}_{k} ) ( {P}_{s} ( {t}_{k} ) - {x}_{k} )}{\vert {P}_{s} ( {t}_{k} ) - {x}_{k} \vert} ) \\ - \frac{1}{λ} [ \begin{matrix}\frac{{a}_{s}^{T} ( {t}_{k} ) ( {P}_{s} ( {t}_{k} ) - {x}_{k} )}{\vert {P}_{s} ( {t}_{k} ) - {x}_{k} \vert} \\ + \frac{{\vert {v}_{s} ( {t}_{k} ) \vert}^{2}}{\vert {P}_{s} ( {t}_{k} ) - {x}_{k} \vert} - \frac{{[ {v}_{s}^{T} ( {t}_{k} ) ( {P}_{s} ( {t}_{k} ) - {x}_{k} ) ]}^{2}}{{\vert {P}_{s} ( {t}_{k} ) - {x}_{k} \vert}^{3}}\end{matrix} ]\end{matrix} ] + {v}_{k} ( {t}_{k} ) \qquad ( 6 )$$

where λ=c/f, c denotes the speed of light, f denotes the carrier frequency, superscript T denotes transpose, and P denotes a vector.

$$[ \begin{matrix}- \frac{1}{λ} ( \frac{{v}_{s}^{T} ( {t}_{k} ) ( {P}_{s} ( {t}_{k} ) - {x}_{k} )}{\vert {P}_{s} ( {t}_{k} ) - {x}_{k} \vert} ) \\ - \frac{1}{λ} [ \begin{matrix}\frac{{a}_{s}^{T} ( {t}_{k} ) ( {P}_{s} ( {t}_{k} ) - {x}_{k} )}{\vert {P}_{s} ( {t}_{k} ) - {x}_{k} \vert} \\ + \frac{{\vert {v}_{s} ( {t}_{k} ) \vert}^{2}}{\vert {P}_{s} ( {t}_{k} ) - {x}_{k} \vert} - \frac{{[ {v}_{s}^{T} ( {t}_{k} ) ( {P}_{s} ( {t}_{k} ) - {x}_{k} ) ]}^{2}}{{\vert {P}_{s} ( {t}_{k} ) - {x}_{k} \vert}^{3}}\end{matrix} ]\end{matrix} ]$$

is a 2×1 vector. There are two parts in zₖ. The first part, that is, the first row in above-mention vector, is the Doppler shifts in equation (1); the second part, that is, the second row in above-mentioned vector, is the Doppler rates which are actually the derivative of Doppler shifts (the first part); and obviously, zₖ is nonlinear.

The sigma points in the cUKF may be calculated as follows:

$${χ}_{0} = {\overline{x}}_{k - 1} \qquad ( 7 )$$

$${χ}_{i} = {\overline{x}}_{k - 1} + {ϛ ( \sqrt{{P}_{{x}_{k - 1}}} )}_{i} , for i = 1 , ... , L \qquad ( 8 )$$

$${χ}_{i} = {\overline{x}}_{k - 1} - {ϛ ( \sqrt{{P}_{{x}_{k - 1}}} )}_{i} , for i = L + 1 , ... , 2 L \qquad ( 9 )$$

where ç denotes a scaling factor that determines the spread of the sigma points relative to corresponding mean, x̅ₖ₋₁ denotes sample average at time instant k−1, and Pₓ_{_{k−1}} denotes state covariance at time instant k−1. Above-mentioned sigma points may be then fed through the state and measurement equations; and resulting distributions may be approximated with weighted sample means and weighted sample covariances.

Due to the constrains of ground-based EMI, sigma points may need to be projected using the following procedure to perform p_{σ}[p_{σ}^{x}, p_{σ}^{y}, p_{σ}^{z}]^{T}→p_{∂}=[p_{∂}^{x}, p_{∂}^{y}, p_{∂}^{z}]^{T}, where p_{σ} is a sigma point, and p_{∂} is a projected sigma point. 1) The sigma point may be converted into a corresponding position in geodetic latitude, longitude, and altitude (LLA) coordinate system; 2) the altitude may be set to zero or a fixed height to obtain a new position in the LLA coordinate system; and 3) new position in the LLA coordinate system may be converted into a position in the ECEF coordinate system to obtain the projected sigma point, where the procedure may refer to geodetic LLA for more details.

The time update equations may be described as follows:

$${χ}_{k / t}^{x} = f ( {χ}_{t}^{x} , {χ}_{t}^{w} ) \qquad ( 10 )$$

$${\hat{x}}_{k}^{-} = {\sum }_{i = 0}^{2 L} {w}_{i}^{m} {χ}_{k / ti}^{x} \qquad ( 11 )$$

$${\hat{P}}_{{x}_{k}}^{-} = {\sum }_{i = 0}^{2 L} {w}_{i}^{c} ( {χ}_{k / ti}^{x} - {\hat{x}}_{k}^{-} ) {( {χ}_{k / ti}^{x} - {\hat{x}}_{k}^{-} )}^{T} + {Q}_{k} \qquad ( 12 )$$

where χₜ^{x} denotes the sigma point for state at time index t; χₜ^{w} denotes the sigma point for noise at time index t for the time update equations; \hat{x}_{k̅} denotes estimated average state; \hat{P}ₓ_{_{k̅}}, denotes estimated average state covariance; T denotes an operator; i denotes an index of a sigma point;

$${w}_{i}^{m} = {w}_{i}^{c} = \frac{1}{2 ( L + λ )} ;$$

and Qₖ denotes the covariance of process noise.

The measurement update equations may be described as follows:

$${χ}_{k / t}^{z} = h ( {χ}_{t}^{x} , {χ}_{t}^{v} ) \qquad ( 13 )$$

$${\hat{z}}_{k}^{-} = {\sum }_{i = 0}^{2 L} {w}_{i}^{m} {χ}_{k / ti}^{z} \qquad ( 14 )$$

$${\hat{P}}_{{z}_{k}}^{-} = {\sum }_{i = 0}^{2 L} {w}_{i}^{c} ( {χ}_{k / ti}^{z} - {\hat{z}}_{k}^{-} ) {( {χ}_{k / ti}^{z} - {\hat{z}}_{k}^{-} )}^{T} + {R}_{k} \qquad ( 15 )$$

$${\hat{P}}_{{x}_{k} {z}_{k}}^{-} = {\sum }_{i = 0}^{2 L} {w}_{i}^{c} ( {χ}_{k / ti}^{x} - {\hat{x}}_{k}^{-} ) {( {χ}_{k / ti}^{z} - {\hat{z}}_{k}^{-} )}^{T} \qquad ( 16 )$$

where χₜ^{w} denotes the sigma point for noise at time index t for the measurement update equations; \hat{z}_{k̅} denotes estimated average measurement; \hat{P}_{z̅}_{ₖ}, denotes estimated average measurement covariance; the weights are specified as

$${w}_{0}^{m} = \frac{λ}{L + λ} , {w}_{0}^{c} = \frac{λ}{L + λ} + ( 1 - {α}^{2} + β ) ,$$

and

$${w}_{i}^{m} = {w}_{i}^{c} = \frac{1}{2 ( L + λ )}$$

for i=1, 2 . . . 2L; Rₖ denotes the covariance of the measurement noises; and α, β, and λ may be used to taper the spread of the sigma points relative to prior mean.

In the present disclosure, implementing the cUKF for SSG is described as the following. 1) Sigma points (shown in equations 7-9) may be calculated using previous projected state estimates (e.g., from previous clock); 2) sigma points, which are not in the constrained solution space, may be projected into the feasible region (refers to above-mentioned projection procedure) to obtain projected sigma points; 3) projected sigma points may be run through the time update equations (equations 10-12) to obtain time-projected sigma points and to obtain the updated state; 4) the state estimates which are not in the constrained solution space may be projected into the feasible region using same algorithm (refers to above-mentioned projection procedure) as in step 2; and 5) time-projected sigma points after the time update may be run through measurement update equations (equations 13-16) to obtain a measurement update. The feasible region (that is, constrained solution space) may be a surface of the Earth. Initial sigma points may be specified according to actual needs, which may not be limited in various embodiments of the present disclosure. The sequence in one clock may be fixed in the order of 1) and 5). For example, results from previous step(s) may be used/incorporated into following step(s). Exemplary steps may be repeated in next clock from 1) to 5).

Performance bounds for SSG are described in the present disclosure hereinafter. To evaluate SSG performance, recursive constrained Posterior Cramér-Rao Bound (rcPCRB) may be implemented. rcPCRB is the theoretical performance bound and uniquely suited to gauge the mean squared error optimality of iterative nonlinear estimation algorithms.

Estimation mean square error (MSE) may be defined as follows:

$$\sum = {𝔼}_{p ( z \vert x )} \{ {[ \hat{x} ( z ) - x ] [ \hat{x} ( z ) - x ]}^{T} \} \qquad ( 17 )$$

$${[ \sum ]}_{ii} \geq {[ {J}^{- 1} ]}_{ii} = C \qquad ( 18 )$$

where [Σ]ᵢᵢ denotes the elements in the ith row and ith column of the matrix; J denotes the Fisher Information Matrix (FIM); and C denotes the Cramér-Rao Bound (RCB) which is defined as the inverse of the FIM.

J represents a theoretical lower bound on the covariance of any unbiased estimator which may be defined as follows:

$$J = - {𝔼}_{p ( z \vert x )} \{ {Δ}_{x}^{x} log p ( z \vert x ) \} \qquad ( 19 )$$

where Δ_{α}^{β} denotes the (m×n) Hessian Matrix w.r.t (i.e., with respect to) parameter vectors α(m×1) and ß(n×1); and p(z|x) denotes a conditional probability density function.

When the parameter vector is random with known statistics, the Bayesian CRB, also known as the Posterior Cramér-Rao Bound (PCRB) may be defined as follows:

$${J}^{B} = - {𝔼}_{p ( z , x )} \{ {Δ}_{x}^{x} log p ( z , x ) \} \qquad ( 20 )$$

The recursive Posterior Cramér-Rao Bound may obtain corresponding recursive properties through the use of the PCRB framework and Markovian Chain attributes. rcPCRB may be a bound well-suited to gauge the optimality of iterative nonlinear estimation algorithms.

The rcPCRB may be defined as follows:

$${J}_{k + 1}^{B} = {D}_{k}^{22} - {{D}_{k}^{21} ( {J}_{k}^{B} + {D}_{k}^{11} )}^{- 1} {D}_{k}^{12} \qquad ( 21 )$$

$${D}_{k}^{11} = {𝔼}_{p ( {x}_{k} )} \{ - {Δ}_{{x}_{k}}^{{x}_{k}} log p ( {x}_{k + 1} \vert {x}_{k} ) \} \qquad ( 22 )$$

$${[ {D}_{k}^{21} ]}^{T} = {D}_{k}^{12} = {𝔼}_{p ( {x}_{k} )} \{ - {Δ}_{{x}_{k}}^{{x}_{k + 1}} log p ( {x}_{k + 1} \vert {x}_{k} ) \} \qquad ( 23 )$$

$$\begin{matrix}{D}_{k}^{22} = \\ {𝔼}_{p ( {z}_{k} \vert {x}_{k} )} \{ {J}_{k + 1} \} + {𝔼}_{p ( {x}_{k} )}\end{matrix} \{ - {Δ}_{{x}_{k + 1}}^{{x}_{k + 1}} log p ( {x}_{k + 1} \vert {x}_{k} ) \} \qquad ( 24 )$$

For the cases with constraints, a null space kernel of the gₖ in equation (5) may need to be determined. Then the rcPCRB for SSG may be calculated as follows:

$${J}_{k + 1} = {U}_{k + 1}^{T} [ {D}_{k}^{22} - {D}_{k}^{21} {{U}_{k} ( {J}_{k} + {U}_{k}^{T} {D}_{k}^{11} {U}_{k} )}^{- 1} {U}_{k}^{T} {D}_{k}^{12} ] {U}_{k + 1} \qquad ( 25 )$$

$${D}_{k}^{11} = {Q}_{k}^{- 1} \qquad ( 26 )$$

$${D}_{k}^{12} = - {Q}_{k}^{- 1} \qquad ( 27 )$$

$${D}_{k}^{21} = {[ {D}_{k}^{12} ]}^{T} \qquad ( 28 )$$

$${D}_{k}^{22} = {𝔼}_{p ( {z}_{k} \vert {x}_{k} )} \{ {J}_{k + 1} \} + {Q}_{k}^{- 1} \qquad ( 29 )$$

where Uₖ₊₁ is the matrix, and columns of the matrix may form an orthonormal basis for the null space gₖ. Monte Carlo integration may be configured to compute equation (29).

Numerical simulation is described in detail in the present disclosure hereinafter.

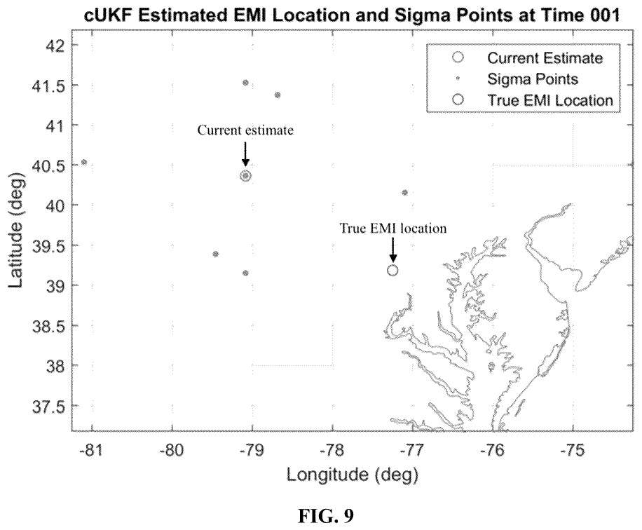

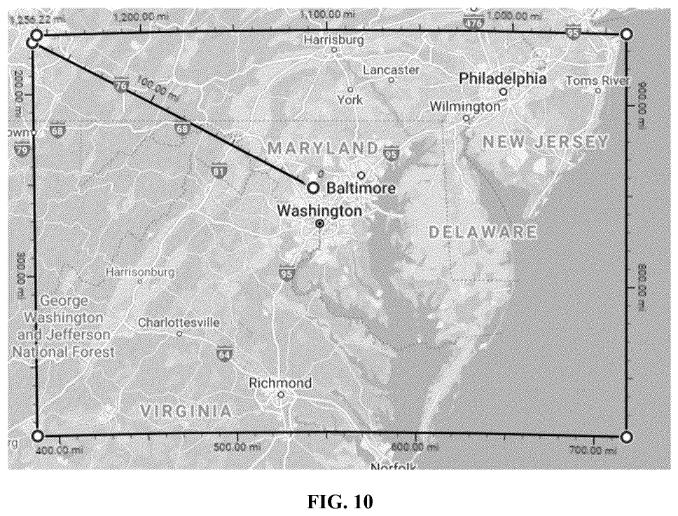

For cUKF initialization, initial position and related projected sigma points may be shown in FIG. 9. For comparison purposes, corresponding area in the Google Map may be also illustrated in FIG. 10. Initial sigma points may be configured to be well separated, so that any location in the field of view (FOV) of the satellite may be a potential EMI source location.

SSG results of various RF bands at SNR=−2 dB (SNR denotes signal to noise ratio) are described hereinafter. Using blind detection algorithms for Doppler shifts, the standard deviation (std) values of the Doppler estimation of a UHF band carrier frequency, 320 MHz, 1.54 Hz (for Doppler shift) and 0.248 Hz/s (for Doppler rate) at SNR=−2 dB may be obtained. Values may be configured in cUKF according to actual needs, which may not be limited in various embodiments of the present disclosure; and the Doppler estimation may be used as the measurements.

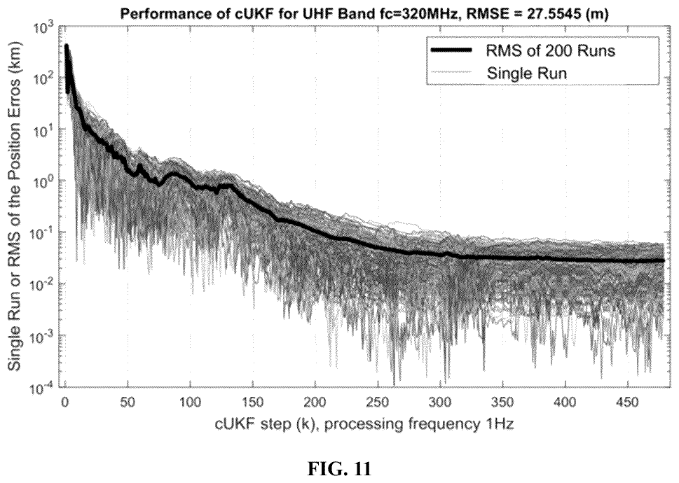

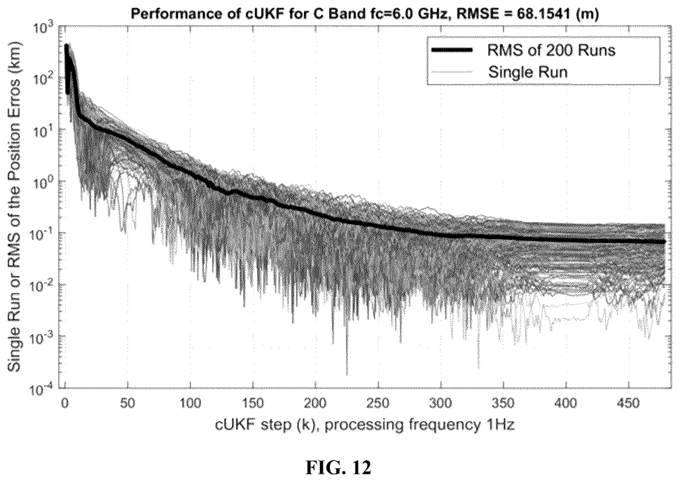

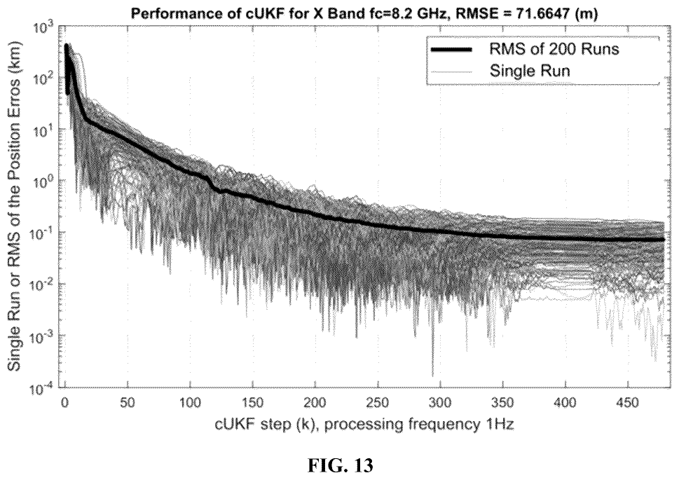

Results of 200 runs are illustrated in FIG. 11, where the line represents a single run while the black bold line represents the root mean square error (RMSE) of 200 runs. SSG accuracy with 27.5 meters may be obtained according to data of 200 runs. Similarly, SSG results for C and X bands illustrated in FIG. 12 and FIG. 13 respectively may be obtained according to various embodiments of the present disclosure. FIG. 11 shows the performance of cUKF for the UHF band. Referring to FIG. 11, the geolocation accuracy in the term of RMSE may be about 27.5545 meters. FIG. 12 shows the performance of cUKF for the C band. Referring to FIG. 12, the geolocation accuracy in the term of RMSE may be about 68.1541 meters. FIG. 13 shows the performance of cUKF for the X band. Referring to FIG. 13, the geolocation accuracy in the term of RMSE may be about 71.6647 meters.

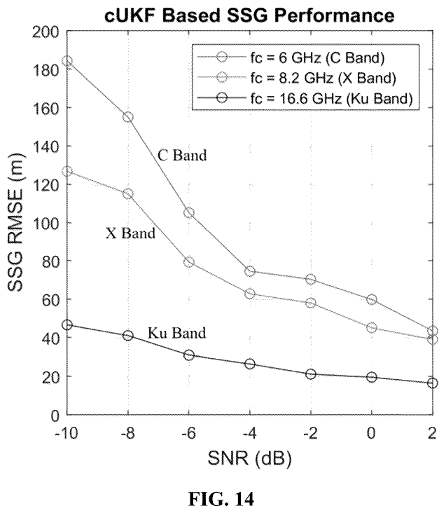

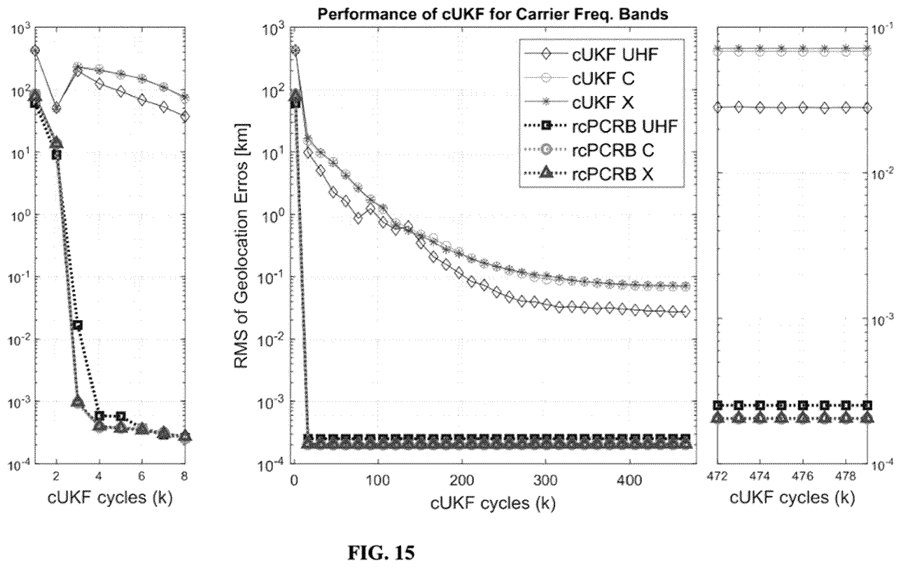

SSG results of various RF bands at various SNR levels are described herein. The SSG for all bands of interest may be summarized in FIG. 14; and results of rcPCRB may be shown in FIG. 15 along with the cUKF performance, where the SNR may be configured to −2 dB approximately. Referring to FIG. 14, the geolocation accuracy may be related to both the carrier frequencies and SNR levels. The higher the frequency invokes, the more accurate geolocation is. Higher SNR level (i.e., stronger EMI signal) may generate more accurate geolocation. Referring to FIG. 15, rcPCRB may provide a performance upper bound for the cUKF.

According to various embodiments of the present disclosure, the passive Doppler based cUKF for SSG system to rapidly position the ground-based EMI sources is provided. Both Doppler shift and Doppler rate may be used to in cUKF to enable quick convergence of sigma points. The practical scenario may be simulated to evaluate the SSG solution provided in the present disclosure; and the feasibility of the SSG solution may be demonstrated on simulated RF data and SNR levels.

Various embodiments of the present disclosure provide a device for passive SSG of ground-based EMI sources. The device includes a memory, configured to store program instructions for performing a method for passive SSG of ground-based EMI sources; and a processor, coupled with the memory and, when executing the program instructions, configured for: simulating a scenario based on an EMI source and a satellite specified by a TLE file; and calculating positions, velocities and accelerations of the satellite at different time instants of the simulated scenario; calculating Doppler shifts and Doppler rates according to the positions, the velocities and the accelerations of the satellite at the different time instants; and implementing a constrained unscented Kalman filter (cUKF) based on the Doppler shifts and the Doppler rates; and calculating a recursive constrained posterior Cramér-Rao bound (rcPCRB); and fine tuning the cUKF using the calculated rcPCRB.

Various embodiments of the present disclosure provide a non-transitory computer-readable storage medium, containing program instructions for, when being executed by a processor, performing a method for passive SSG of ground-based EMI sources. The method includes simulating a scenario based on an EMI source and a satellite specified by a TLE file; and calculating positions, velocities and accelerations of the satellite at different time instants of the simulated scenario; calculating Doppler shifts and Doppler rates according to the positions, the velocities and the accelerations of the satellite at the different time instants; and implementing a constrained unscented Kalman filter (cUKF) based on the Doppler shifts and the Doppler rates; and calculating a recursive constrained posterior Cramér-Rao bound (rcPCRB); and fine tuning the cUKF using the calculated rcPCRB.

The embodiments disclosed herein may be exemplary only. Other applications, advantages, alternations, modifications, or equivalents to the disclosed embodiments may be obvious to those skilled in the art and be intended to be encompassed within the scope of the present disclosure.

What is claimed is:

1. A method for passive single satellite geolocation (SSG) of ground-based electromagnetic interference (EMI) sources, comprising:
simulating a scenario based on an EMI source and a satellite specified by a two-line element (TLE) file; and calculating positions, velocities and accelerations of the satellite at different time indexes of the simulated scenario;
calculating Doppler shifts and Doppler rates according to the positions, the velocities and the accelerations of the satellite at the different time indexes; and implementing a constrained unscented Kalman filter (cUKF) based on the Doppler shifts and the Doppler rates to obtain an updated state; and
calculating a recursive constrained posterior Cramér-Rao bound (rcPCRB); and fine tuning the cUKF using the calculated rcPCRB to obtain an updated cUKF.

2. The method according to claim 1, wherein implementing the cUKF includes:
calculating sigma points in the cUKF using previous projected state estimates;
projecting a part of the sigma points which are not in a constrained solution space into a feasible region to obtain projected sigma points;
running the projected sigma points through time update equations to obtain time-projected sigma points and to obtain a time update;
projecting state estimates which are not in the constrained solution space into the feasible region to obtain projected state estimates; and
running the time-projected sigma points through measurement update equations to obtain a measurement update, wherein the time update and the measurement update provide the updated state according to system dynamics and measurements, respectively.

3. The method according to claim 2, wherein projecting the part of sigma points which are not in the constrained solution space includes:
converting each sigma point into a position in a latitude, longitude, and altitude (LLA) coordinate system;
setting an altitude of the position to zero or a fixed height to obtain a new position in the LLA coordinate system; and
converting the new position in the LLA coordinate system to a position in an Earth-centered and Earth-fixed (ECEF) coordinate system.

4. The method according to claim 1, wherein simulating the scenario based on the EMI source and the satellite includes:
starting with the TLE file and propagating satellite states using a simplified perturbations model 4 (SGP4); and
calculating angles of azimuth and elevation in a view of EMI source, wherein if the elevation angles are greater than +8 degrees, the satellite receives RF signals from the EMI source.

5. The method according to claim 4, wherein:
SGP4 outputs are positions in a True Equator Mean Equinox (TEME) coordinate system;
the positions in the TEME coordinate system are converted to positions in an Earth-centered and Earth-fixed (ECEF) coordinate system; and
the positions in the ECEF coordinate system are converted to positions in a latitude, longitude, and altitude (LLA) coordinate system.

6. The method according to claim 2, after projecting the state estimates which are not in the constrained solution space into the feasible region, further including:
using the projected state estimates to calculate updated sigma points.

7. The method according to claim 2, wherein:
the constrained solution space is a surface of the Earth.

8. A device, comprising:
a memory, configured to store program instructions for performing a method for passive single satellite geolocation (SSG) of ground-based electromagnetic interference (EMI) sources; and
a processor, coupled with the memory and, when executing the program instructions, configured for:
simulating a scenario based on an EMI source and a satellite specified by a two-line element (TLE) file; and calculating positions, velocities and accelerations of the satellite at different time indexes of the simulated scenario;
calculating Doppler shifts and Doppler rates according to the positions, the velocities and the accelerations of the satellite at the different time indexes; and
implementing a constrained unscented Kalman filter (cUKF) based on the Doppler shifts and the Doppler rates to obtain an updated state; and
calculating a recursive constrained posterior Cramér-Rao bound (rcPCRB);
and fine tuning the cUKF using the calculated rcPCRB to obtain an updated cUKF.

9. The device according to claim 8, wherein for implementing the cUKF, the processor is configured to:
calculate sigma points in the cUKF using previous projected state estimates;
project a part of the sigma points which are not in a constrained solution space into a feasible region to obtain projected sigma points;
run the projected sigma points through time update equations to obtain time-projected sigma points and to obtain a time update;
project state estimates which are not in the constrained solution space into the feasible region to obtain projected state estimates; and
run the time-projected sigma points through measurement update equations to obtain a measurement update, wherein the time update and the measurement update provide the updated state according to system dynamics and measurements, respectively.

10. The device according to claim 9, wherein for the part of sigma points which are not in the constrained solution space, the processor is configured to:
convert each sigma point into a position in a latitude, longitude, and altitude (LLA) coordinate system;
set an altitude of the position to zero or a fixed height to obtain a new position in the LLA coordinate system; and
convert the new position in the LLA coordinate system to a position in an Earth-centered and Earth-fixed (ECEF) coordinate system.

11. The device according to claim 8, wherein for simulating the scenario based on the EMI source and the satellite, the processor is configured to:
start with the TLE file and propagating satellite states using a simplified perturbations model 4 (SGP4); and
calculate angles of azimuth and elevation in a view of EMI source, wherein if the elevation angles are greater than +8 degrees, the satellite receives RF signals from the EMI source.

12. The device according to claim 11, wherein:
SGP4 outputs are positions in a True Equator Mean Equinox (TEME) coordinate system;
the positions in the TEME coordinate system are converted to positions in an Earth-centered and Earth-fixed (ECEF) coordinate system; and
the positions in the ECEF coordinate system are converted to positions in a latitude, longitude, and altitude (LLA) coordinate system.

13. The device according to claim 9, after projecting the state estimates which are not in the constrained solution space into the feasible region, the processor is further configured to:
use the projected state estimates to calculate updated sigma points.

14. The device according to claim 9, wherein:
the constrained solution space is a surface of the Earth.

15. A non-transitory computer-readable storage medium, containing program instructions for, when being executed by a processor, performing a method for passive single satellite geolocation (SSG) of ground-based electromagnetic interference (EMI) sources, the method comprising:
simulating a scenario based on an EMI source and a satellite specified by a two-line element (TLE) file; and calculating positions, velocities and accelerations of the satellite at different time indexes of the simulated scenario;
calculating Doppler shifts and Doppler rates according to the positions, the velocities and the accelerations of the satellite at the different time indexes; and implementing a constrained unscented Kalman filter (cUKF) based on the Doppler shifts and the Doppler rates to obtain an updated state; and
calculating a recursive constrained posterior Cramér-Rao bound (rcPCRB); and fine tuning the cUKF using the calculated rcPCRB to obtain an updated cUKF.

16. The storage medium according to claim 15, wherein for implementing the cUKF, the processor is configured to:
calculate sigma points in the cUKF using previous projected state estimates;
project a part of the sigma points which are not in a constrained solution space into a feasible region to obtain projected sigma points;
run the projected sigma points through time update equations to obtain time-projected sigma points and to obtain a time update;
project state estimates which are not in the constrained solution space into the feasible region to obtain projected state estimates; and
run the time-projected sigma points through measurement update equations to obtain a measurement update, wherein the time update and the measurement update provide the updated state according to system dynamics and measurements, respectively.

17. The storage medium according to claim 16, wherein for the part of sigma points which are not in the constrained solution space, the processor is configured to:
convert each sigma point into a position in a latitude, longitude, and altitude (LLA) coordinate system;
set an altitude of the position to zero or a fixed height to obtain a new position in the LLA coordinate system; and
convert the new position in the LLA coordinate system to a position in an Earth-centered and Earth-fixed (ECEF) coordinate system.

18. The storage medium according to claim 15, wherein for simulating the scenario based on the EMI source and the satellite, the processor is configured to:
start with the TLE file and propagating satellite states using a simplified perturbations model 4 (SGP4); and
calculate angles of azimuth and elevation in a view of EMI source, wherein if the elevation angles are greater than +8 degrees, the satellite receives RF signals from the EMI source.

19. The storage medium according to claim 18, wherein:
SGP4 outputs are positions in a True Equator Mean Equinox (TEME) coordinate system;
the positions in the TEME coordinate system are converted to positions in an Earth-centered and Earth-fixed (ECEF) coordinate system; and
the positions in the ECEF coordinate system are converted to positions in a latitude, longitude, and altitude (LLA) coordinate system.

20. The storage medium according to claim 16, after projecting the state estimates which are not in the constrained solution space into the feasible region, the processor is further configured to:
use the projected state estimates to calculate updated sigma points.
